(19) United States
(12) Patent Application Publication
(10) Pub. No.: US 2013/0179747 A1
(43) Pub. Date: Jul. 11, 2013

(54) METHOD AND APPARATUS FOR DATA RECEPTION ERROR RECOVERY IN MOBILE TERMINAL

(71) Applicant: SAMSUNG ELECTRONICS CO. LTD., Suwon-si (KR)

(72) Inventor: Hyunjin PARK, Anyang-si (KR)

(73) Assignee: SAMSUNG ELECTRONICS CO. LTD., Suwon-si (KR)

(21) Appl. No.: 13/713,551

(22) Filed: Dec. 13, 2012

(30) Foreign Application Priority Data
Jan. 10, 2012 (KR) 10-2012-0002822

(51) Int. Cl. H04L 1/08

(52) U.S. Cl. CPC H04L 1/08
USPC 714/748

(57) ABSTRACT

A method and an apparatus for data reception error recovery in a mobile terminal are provided. When a mobile terminal detects an error in data received from a memory card, the method and the apparatus enable the mobile terminal to re-receive the data from the memory card for error recovery. The data reception error recovery method, for a mobile terminal connected with a memory card, includes sending a data request command to the memory card, determining whether data corresponding to the data request command is received from the memory card, and sending, when corresponding data is not received from the memory card, a state transition command, which forces the memory card to transition to a transfer state so that the memory card is able to send data to the mobile terminal, to the memory card.

### PRIORITY

This application claims the benefit under 35 U.S.C. §119(a) of a Korean patent application filed on Jan. 10, 2012 in the Korean Intellectual Property Office and assigned Serial No. 10-2012-0002822, the entire disclosure of which is hereby incorporated by reference.

### BACKGROUND OF THE INVENTION

1. Field of the Invention

The present invention relates to recovery of a data reception error in a mobile terminal More particularly, the present invention relates to a method and apparatus for recovery of a data reception error in a mobile terminal connected with a memory card.

2. Description of the Related Art

Memory cards are small storage devices that are connectable to mobile terminals. For example, a memory card may be embedded in a mobile terminal. Because a memory card is small in size (e.g., similar to a fingernail) and is lightweight, it is well suited to a mobile terminal. In a mobile terminal, such as a cellular phone or digital camera, a memory card having a NAND flash memory or the like is used to store moving images, photographs and the like. When a mobile terminal is connected with a memory card, the mobile terminal may receive data from the memory card and store the received data in an internal storage. Here, a method and apparatus for data reception error recovery may be employed in the mobile terminal

In an error recovery technique of the related art, when a mobile terminal detects an error in received data, it attempts to receive the same data to recover from the error. However, when the error is caused by a malfunction of the memory card, it may be difficult to recover from the error. For example, the memory card may send data in response to a command from the mobile terminal, but the mobile terminal may fail to receive the data. In addition, although data may be received by the mobile terminal, the data may be useless. As such, the mobile terminal requests the memory card to send the same data again. However, the memory card may send only a response to the request but not resend actual data based on the assumption that the requested data had been successfully sent.

Therefore, a need exists for an improved system and method for recovering data in a mobile terminal.

### SUMMARY OF THE INVENTION

Aspects of the present invention are to address at least the abovementioned problems and/or disadvantages and to provide at least the advantages described below. Accordingly, an aspect of the present invention is to provide a data reception error recovery method and apparatus that enable, when an error is detected in data received from a memory card, a mobile terminal to receive the data again for error recovery.

In accordance with an aspect of the present invention, a method for data reception error recovery in a mobile terminal connected with a memory card is provided. The method includes sending a data request command to the memory card, determining whether data corresponding to the data request command is received from the memory card, and sending, when corresponding data is not received from the memory card, a state transition command, which forces the memory card to transition to a transfer state so that the memory card is able to send data to the mobile terminal, to the memory card.

In accordance with another aspect of the present invention, an apparatus for data reception error recovery in a mobile terminal connected with a memory card is provided. The apparatus includes an interface unit for connecting the memory card and the mobile terminal, a storage unit for storing data received from the memory card, and a control unit for determining whether data corresponding to a data request command is received from the memory card, and for sending, when corresponding data is not received from the memory card, a state transition command, which forces the memory card to transition to a transfer state so that the memory card is able to send data to the mobile terminal, to the memory card. Here, the control unit may include a data requester for sending a data request command to the memory card, a state change requester for sending a state transition command to the memory card, a buffer for storing data received from the memory card, a data checker for determining whether data is received from the memory card in return to a data request command, and a storage controller for controlling, when data is not received from the memory card, the state change requester to send a state transition command to the memory card.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a mobile terminal according to an exemplary embodiment of the present invention;

FIG. 2 is a block diagram of a control unit in a mobile terminal according to an exemplary embodiment of the present invention;

FIG. 3 is a flowchart of a method for data reception error recovery according to an exemplary embodiment of the present invention; and

FIG. 4 is a sequence diagram of a method for data reception error recovery according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, certain terms may be used to explain the invention. However, the meaning of specific terms or words used in the specification and the claims should not be limited to their literal or commonly employed sense, but should be construed in accordance with the spirit of the invention. The following description of the various embodiments is to be construed as exemplary only and does not describe every possible instance of the invention. Therefore, it should be understood that various changes may be made and equivalents may be substituted for elements of the invention. In the drawings, some elements are exaggerated or only outlined in brief, and thus may not be drawn to scale. That is, the present invention is not limited by relative sizes of objects and intervals between objects in the drawings.

In general, memory cards include a Secure Digital (SD) card, a Compact Flash (CF) card, an extreme Digital (xD) Picture card, a Multi Media Card (MMC), and an embedded Multi Media Card (eMMC).

In exemplary embodiments of the present invention, a mobile terminal includes an interface for electrical and physical connection with a memory card. The mobile terminal acts as a host for the memory card and may perform a read operation, recovery operation, storage operation, and the like. The mobile terminal may perform a read operation to receive data from the memory card and may perform a storage operation to move data, which is temporarily stored by a read operation in a buffer, to an internal storage. The mobile terminal may perform a recovery operation to recover from an error in received data. In an exemplary implementation, the recovery operation may include an operation that forces the memory card to transition from a sending-data state to a transfer state. In the transfer state, the memory card can send and receive data to and from the mobile terminal. The sending-data state indicates a state in which data reception or transmission is completed. That is, after the memory card completes data transmission or reception in the transfer state, it transitions to the sending-data state.

In the following description, a mobile terminal may be a cellular phone, a smartphone, a tablet computer, a handheld computer, a Portable Multimedia Player (PMP), a Personal Digital Assistant (PDA), a music player like an MP3 player, a digital camera, a portable game console, and the like.

The exemplary method and apparatus for data reception error recovery of the present invention apply to a mobile terminal described above. More particularly, when an error occurs in data received from a memory card (external storage device), the exemplary method and apparatus enable the mobile terminal to recover from the data reception error by forcing the memory card to transition from the sending-data state to the transfer state.

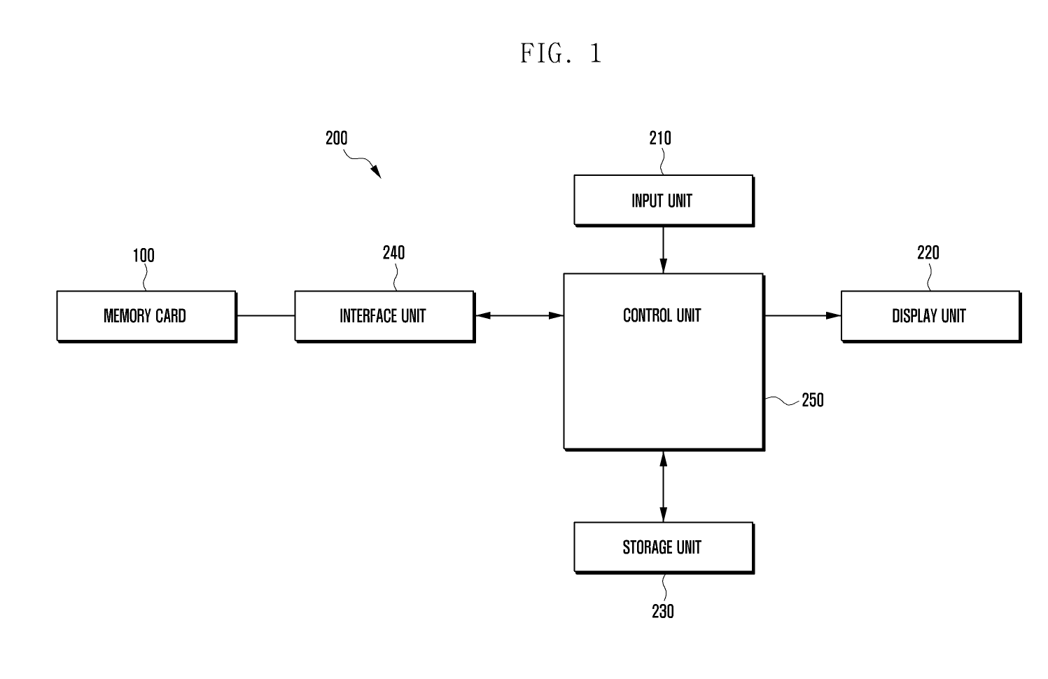

FIG. 1 is a block diagram of a mobile terminal according to an exemplary embodiment of the present invention.

Referring to FIG. 1, the mobile terminal 200 is connected with a memory card 100. The mobile terminal 200 may include an input unit 210, a display unit 220, a storage unit 230, an interface unit 240, and a control unit 250.

The input unit 210 may include a touchscreen and a key input part. Here, the touchscreen is placed on the display unit 220 and generates a touch event, corresponding to a touch gesture made by the user on the touchscreen, that is sent to the control unit 250. The control unit 250 may identify a touch gesture and control other components on the basis of a touch event sent by the touchscreen. More particularly, the control unit 250 may perform a read operation, a recover operation, a store operation, and the like in response to a touch gesture. The touchscreen may be realized using a resistive type, a capacitive type, an electromagnetic induction type, a pressure type, or other type of technology. The key input part may include a plurality of alphanumeric and function keys for inputting alphanumeric information and for setting various functions. The function keys may include direction, side, and shortcut keys associated with corresponding functions. The key input part sends key events generated by the user for setting and controlling the mobile terminal 200 to the control unit 250 and the control unit 250 may control the components according to key events. More particularly, the control unit 250 may perform a read operation, a recovery operation, a storage operation, and the like in response to a key event.

The display unit 220 converts image data from the control unit 250 into an analog signal and displays the analog signal under control of the control unit 250. The display unit 220 may display a menu for controlling an operation of the memory card 100 and, in response to a touch event on the menu, the control unit 250 may control the memory card 100. The display unit 220 may be realized using a flat display panel composed of Liquid Crystal Display (LCD) devices, Organic Light Emitting Diodes (OLEDs), Active Matrix Organic Light Emitting Diodes (AMOLEDs), and the like.

The storage unit 230 is an internal storage device of the mobile terminal 200. The storage unit 230 may store an Operating System (OS) of the mobile terminal 200, various applications, various data such as text, audio or video, and the like. The storage unit 230 may include a data section and a program section. The program section of the storage unit 230 may store an operating system for booting the mobile terminal 200 and operating individual components thereof, and various applications. More particularly, the program section may store an application realizing a recovery operation, which has a function of requesting the memory card 100 to make a state transition. The data section of the storage unit 230 may store data generated in the course of using the mobile terminal 200, data downloaded from an external source, data received from the memory card 100, and the like.

The interface unit 240 connects the memory card 100 with the control unit 250. The interface unit 240 includes an output port to send a command and data to the memory card 100, and an input port to receive a response and data from the memory card 100. The interface unit 240 may further include a power port to supply power such as battery power of the mobile terminal 200 to the memory card 100.

The control unit 250 may control operations of the mobile terminal 200, control signal exchange between internal components thereof, perform data processing, and the like. The control unit 250 may control the supply of power from a battery to the internal components and to the memory card 100. The control unit 250 may execute various applications stored in the program section of the storage unit 230. For example, when an error occurs in data received from the memory card 100, the control unit 250 may perform a recovery operation.

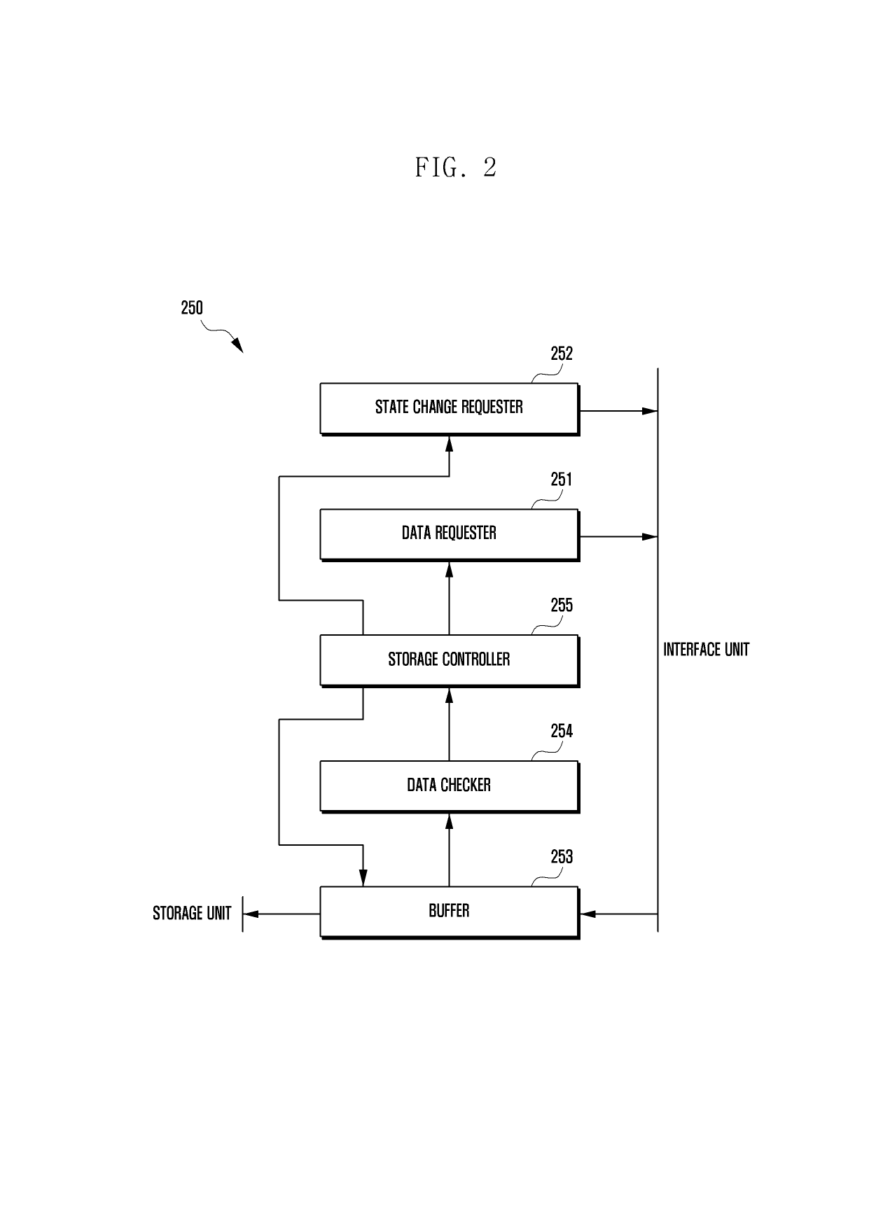

FIG. 2 is a block diagram of a control unit in a mobile terminal according to an exemplary embodiment of the present invention.

Referring to FIG. 2, the control unit 250 may include a data requester 251, a state change requester 252, a buffer 253, a data checker 254, and a storage controller 255. The data requester 251 sends a data request command to the memory card 100. In response to the data request command, the memory card 100 sends the requested data to the mobile terminal 200. The state change requester 252 sends the memory card 100 a state transition command requesting a state transition from the sending-data state to the transfer state. The buffer 253 temporarily stores data received from the memory card 100. The data checker 254 determines whether requested data is received by the buffer 253 from the memory card 100 within a preset time after sending a data request command to the memory card 100. When requested data is received by the buffer 253 within the preset time, the data checker 254 determines whether the data stored in the buffer 253 is valid. Here, a cyclic redundancy check or the like may be used to determine data validity. The data checker 254 notifies the results of data reception time determination and data validity determination to the storage controller 255. The storage controller 255 controls the data requester 251, state change requester 252 and the buffer 253 on the basis of results of data reception time determination and data validity determination. More specifically, when a notification of data being valid is received from the data checker 254, the storage controller 255 controls the buffer 253 to forward the data to the storage unit 230. When a notification of failure of data reception within the preset time or a notification of data being invalid is received from the data checker 254, the storage controller 255 controls the state change requester 252 to send a state transition command, and then controls the data requester 251 to send a data request command again.

Although not shown in FIG. 1, the mobile terminal 200 may further include a mobile communication module for 3G, 3.5G or 4G mobile communication, a wireless local area communication module like a Wi-Fi module, a digital broadcast receiving module like a Digital Multimedia Broadcast (DMB) module, a digital camera module, a speaker, a microphone, a Global Positioning System (GPS) module, and the like. With the digital convergence trend, it should be apparent to those skilled in the art that the mobile terminal 200 may further include a unit comparable to the above-described units, and one unit thereof may be removed or replaced with another unit.

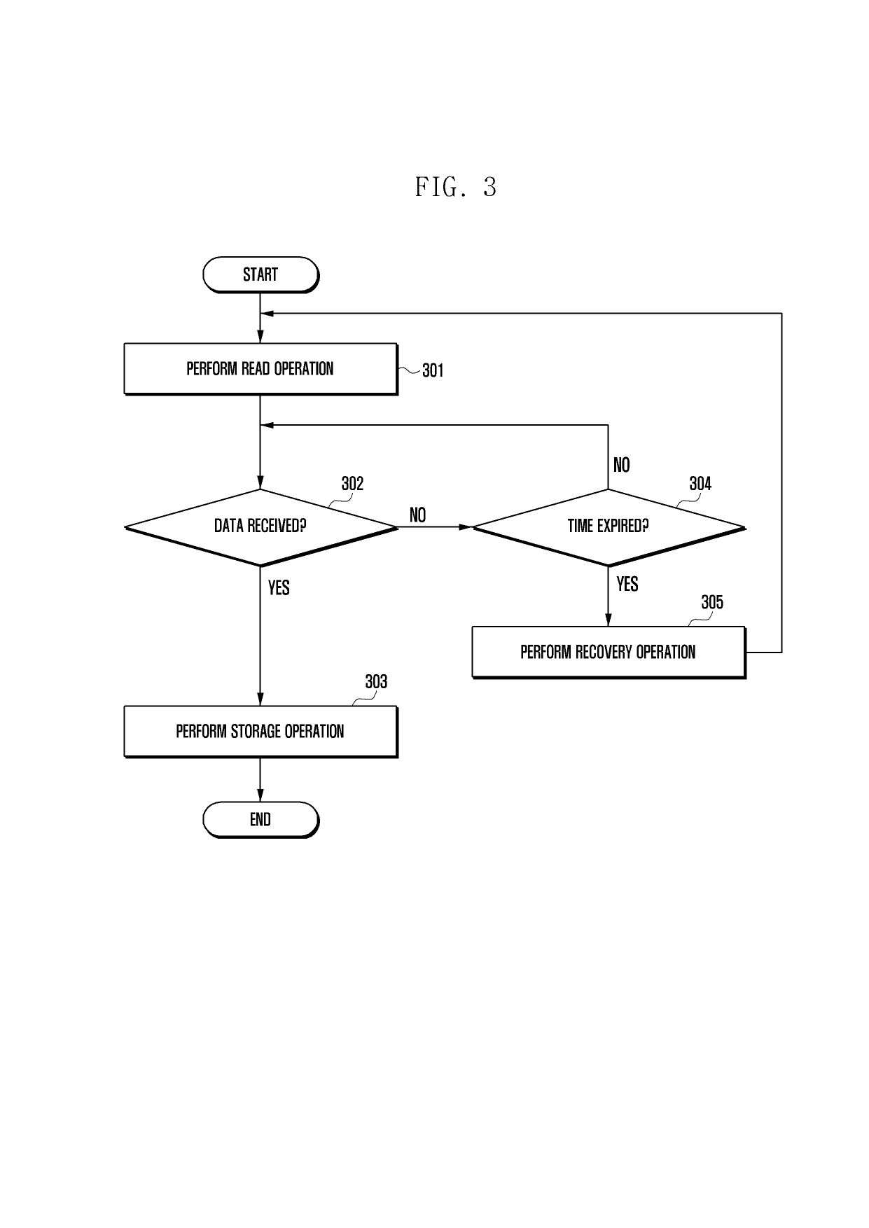

FIG. 3 is a flowchart of a method for data reception error recovery according to an exemplary embodiment of the present invention.

Referring to FIG. 3, the control unit 250 of the mobile terminal 200 performs a read operation in step 301. That is, the control unit 250 sends a data request command to the memory card 100. In response, the memory card 100 sends requested data to the mobile terminal 200. The control unit 250 determines whether requested data is received from the memory card 100 in step 302. When requested data is received, the control unit 250 performs a storage operation in step 303. When requested data is not received, the control unit 250 determines whether a first threshold time has expired after sending the data request command in step 304. When the first threshold time has not expired yet, the control unit 250 returns to step 302. When the first threshold time has expired, the control unit 250 performs a recovery operation in step 305, and returns to step 301 to perform a read operation again. Here, during the recovery operation, a state transition command is sent to the memory card 100.

When requested data is received at step 302, the control unit 250 may determine whether the received data is valid before storing the data at step 303. When the received data is valid, the control unit 250 stores the received data in step 303. When the received data is not valid, the control unit 250 may perform a recovery operation first and then repeat a read operation.

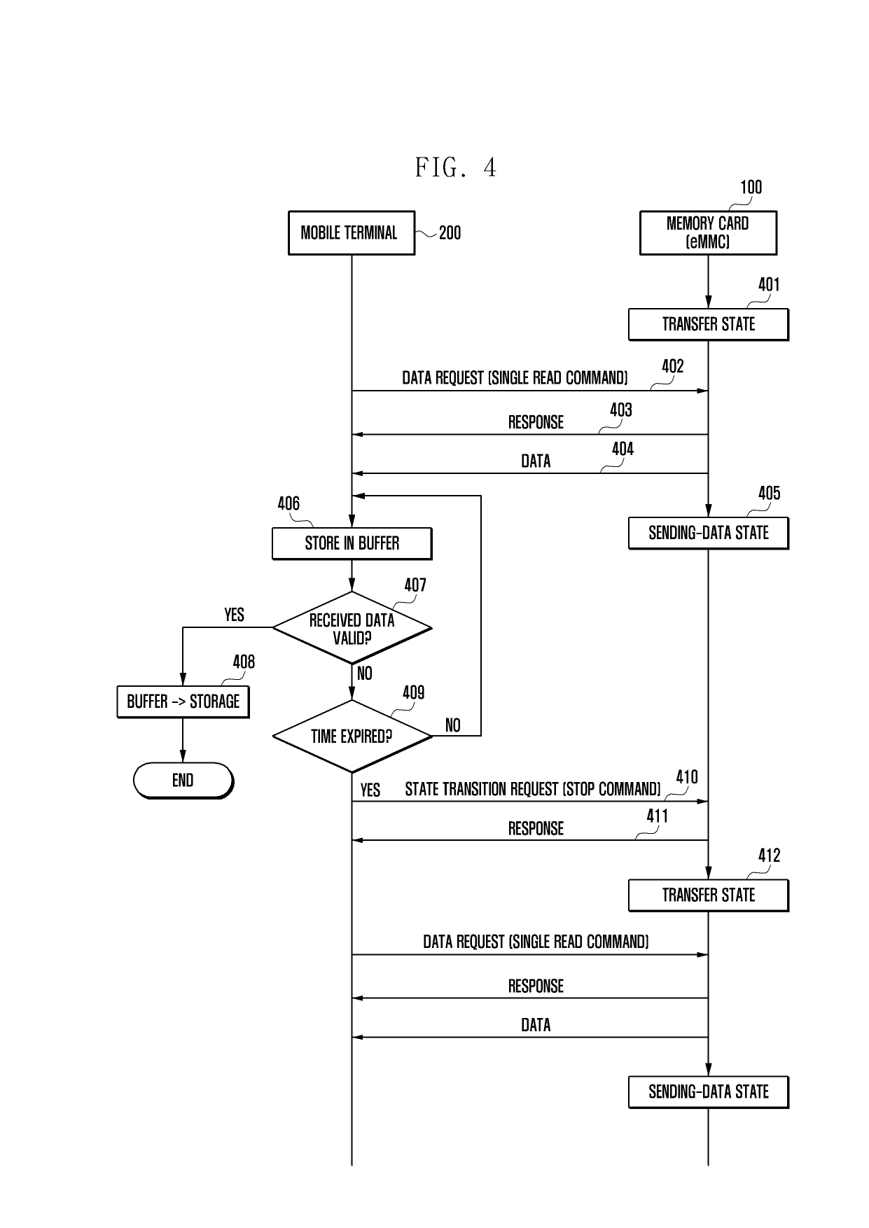

FIG. 4 is a sequence diagram of a method for data reception error recovery according to an exemplary embodiment of the present invention.

FIG. 4 illustrates interactions between the mobile terminal 200 and the memory card 100. Here, the memory card 100 is assumed to be an eMMC.

Referring to FIG. 4, the mobile terminal 200 initializes the memory card 100 for data transmission and reception. Upon initialization, the memory card 100 enters the transfer state in step 401. The mobile terminal 200 sends a data request command to the memory card 100 in step 402. Here, the data request command may be a single-read command. As the memory card 100 operates in blocks, a single-read command corresponds to a request for one block of data. A multi-read command corresponds to a request for multiple blocks of data.

Upon reception of the single-read command, the memory card 100 sends a response to the mobile terminal 200 in step 403. The memory card 100 sends a block of data indicated by the single-read command to the mobile terminal 200 in step 404. After sending the data, the memory card 100 transitions from the transfer state to the sending-data state in step 405.

Upon reception of data corresponding to the single-read command, the mobile terminal 200 temporarily stores the received data in a buffer in step 406. The mobile terminal 200 may use a first flag indicating data reception and data validity and a second flag indicating expiration of a second threshold time. The mobile terminal 200 determines whether requested data is received and whether the received data is valid using the first flag in step 407. When requested data is received and the received data is valid, the mobile terminal 200 moves the data stored in the buffer to the internal storage in step 408 and ends the process.

When requested data is not received or the received data is not valid, the mobile terminal 200 determines whether the second threshold time has expired using the second flag in step 409. When the second threshold time has not yet expired, the mobile terminal 200 returns to step 406. When the second threshold time has expired, the mobile terminal 200 sends a stop command to the memory card 100 in step 410. The stop command is a command requesting the memory card 100 to enter the transfer state. Upon reception of the stop command, the memory card 100 sends a response to the mobile terminal 200 in step 411, and transitions from the sending-data state to the transfer state in step 412. After the memory card 100 transitions to the transfer state, the mobile terminal 200 performs a read operation again. If a read operation were performed without a state transition of the memory card 100, the memory card 100 remaining in the sending-data state may only send a response for the data request but not send actual data under the assumption that the requested data was sent already. Or, the memory card 100 may not send even a response.

Following the transition to the transfer state in step 412, the process between the mobile terminal 200 and the memory card 100 is substantially the same as described above with regard to steps 402 through 405 and thus will not be described further.

The exemplary method for data reception error recovery of the present invention may be implemented as computer programs and may be stored in various computer readable storage media. The computer readable storage media may store program instructions, data files, data structures and combinations thereof. The program instructions may include instructions developed specifically for the present invention and existing general-purpose instructions known to persons skilled in the art. The computer readable storage media may be hardware devices specially designed to store and execute program instructions, and may include magnetic media such as a hard disk, floppy disk and magnetic tape, optical media such as a CD-ROM and DVD, magneto-optical media such as a floptical disk, and memory devices such as a ROM, RAM and flash memory. The program instructions may include machine codes produced by compilers and high-level language codes executable through interpreters. Each hardware device may be replaced with one or more software modules to perform operations according to the present invention, and vice versa.

In an exemplary feature of the present invention, when a mobile terminal connected with a memory card detects an error in data received from the memory card, the exemplary data reception error recovery method and apparatus of the present invention enable the mobile terminal to receive the data again for error recovery.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for data reception error recovery in a mobile terminal connected with a memory card, the method comprising:
sending a data request command to the memory card;
determining whether data corresponding to the data request command is received from the memory card; and
sending, when corresponding data is not received from the memory card, a state transition command, which forces the memory card to transition to a transfer state so that the memory card is able to send data to the mobile terminal, to the memory card.

2. The method of claim 1, further comprising sending, after the sending of the state transition command, a data request command to the memory card again.

3. The method of claim 2, wherein the determining of whether corresponding data is received comprises determining whether corresponding data is received within a threshold time after sending the data request command.

4. The method of claim 3, wherein the determining of whether corresponding data is received further comprises determining, when corresponding data is received within the threshold time, whether the received data is valid.

5. The method of claim 4, further comprising storing, when the received data is valid, the received data in an internal storage unit of the mobile terminal.

6. The method of claim 4, wherein the sending of the state transition command is performed when the received data is not valid.

7. The method of claim 1, wherein the data request command is a command requesting the memory card to send one block of data.

8. An apparatus for data reception error recovery in a mobile terminal connected with a memory card, the apparatus comprising:
an interface unit for connecting the memory card and the mobile terminal;
a storage unit for storing data received from the memory card; and
a control unit for determining whether data corresponding to a data request command is received from the memory card, and for sending, when corresponding data is not received from the memory card, a state transition command, which forces the memory card to transition to a transfer state so that the memory card is able to send data to the mobile terminal, to the memory card.

9. The apparatus of claim 8, wherein the control unit comprises:
a data requester for sending a data request command to the memory card;
a state change requester for sending a state transition command to the memory card;
a buffer for storing data received from the memory card;
a data checker for determining whether data is received from the memory card in return to a data request command; and
a storage controller for controlling, when data is not received from the memory card, the state change requester to send a state transition command to the memory card.

10. The apparatus of claim 9, wherein the storage controller controls, after sending the state transition command, the data requester to send a data request command to the memory card again.

11. The apparatus of claim 10, wherein the data checker determines whether data is received within a threshold time after sending the data request command.

12. The apparatus of claim 11, wherein the data checker determines, when data is received within the threshold time, whether the received data is valid.

13. The apparatus of claim 12, wherein the storage controller controls, when the received data is valid, the buffer to forward the received data to the storage unit.

14. The apparatus of claim 12, wherein the storage controller controls, when the received data is not valid, the state change requester to send a state transition command to the memory card.

15. The apparatus of claim 8, wherein the data request command is a command requesting the memory card to send one block of data.

16. The apparatus of claim 15, wherein the memory card is a Multi Media Card (MMC) or an embedded Multi Media Card (eMMC).
